(19) United States
(12) Patent Application Publication
(10) Pub. No.: US 2026/0243206 A1
(43) Pub. Date: Aug. 20, 2026

(54) FUEL FOR A COMPRESSION ENGINE

(71) Applicant: EURENCO FRANCE SAS, Sorgues (FR)

(72) Inventors: Anne-Gaëlle BATAILLE MORIN, Bures sur Yvette (FR); Richard SAMSON, Saran (FR); Fabrice FOUCHER, Saint Jean le Blanc (FR)

(73) Assignee: EURENCO FRANCE SAS, Sorgues (FR)

(21) Appl. No.: 19/164,944

(22) PCT Filed: Mar. 14, 2024
(86) PCT No.: PCT/FR2024/050303

§ 371 Date: Sep. 12, 2025

(30) Foreign Application Priority Data
Mar. 16, 2023 (FR) FR2302423

(51) Int. Cl. F02D 19/06

(52) U.S. Cl. CPC F02D 19/0644; F02D 19/0689; F02D 19/0692

(57) ABSTRACT

A fuel for combustion engines including 95.00% to 99.75% by mass of ammonia and 0.25% to 5.00% by mass of a pilot fuel consisting of a hydrocarbon having a cetane number of more than 60 and containing 0.02% to 30.0% by mass of an alkyl nitrate or a mixture of alkyl nitrates. Also, a method for obtaining such a fuel.

### FIELD OF INVENTION

The field of the invention is that of fuels for compression ignition engines, more particularly engines for maritime applications. The fuel of the invention is one of a new generation of fuels with reduced environmental impact, such as those commonly referred to as “e-fuels” when produced from low-carbon electricity, low-carbon hydrogen and/or CO₂. They are considered a solution for decarbonising heavy and long-distance transport. The fuel of the invention, which is mainly composed of ammonia, is therefore one of the environmentally friendly alternatives to diesel and heavy fuel oil. The invention relates to an ammonia-type fuel used with a pilot fuel, which ensures better ignition and faster and more energetic combustion of the fuel in the engine.

### STATE OF THE ART

Ammonia (NH₃) is an environmentally friendly alternative and a credible renewable fuel that could soon replace diesel and heavy fuel oil in maritime transport. The combustion of NH₃ produces only water and nitrogen and no carbon molecules (CO₂, CO) or soot particles. Ammonia is a compound with a proven and common manufacturing process, which means that its uses, transport and storage are well known. It is also a product whose cost remains reasonable enough for use as a fuel. Ammonia as a fuel has an energy density that can be used in compression ignition engines but has a low cetane number. Its ignition in diesel engines remains problematic, especially at low engine speeds. Ammonia is stored under pressure (~9 bar) in liquid form in a tank and injected into the engine in liquid or gaseous form.

Various means of improving the ignition of ammonia in a compression ignition engine have been described.

US patent application 2010/288211 describes a process for preparing a mixture of ammonia and heavy fuel oil for use in an internal combustion engine, comprising: (i) supplying ammonia to a metering-mixing module; (ii) providing a supply of heavy fuel to the metering-mixing module; (iii) mixing a predetermined ratio of the heavy fuel and ammonia supplies in the metering-mixing module.

The scientific article “Ignition and combustion study of premixed ammonia using GDI pilot injection in CI engine”, published in Fuel Volume 331, Part 1, 1 Jan. 2023, 125768, describes the benefits of n-heptane as a pilot fuel with ammonia. N-heptane was chosen because of its low viscosity (facilitating injection) and its cetane number (53 to 56), which is close to that of commercial diesel fuel.

US patent application 2011/0259290 describes a combustion engine operating on a mixture of ammonia and a highly combustible substance that burns more easily than ammonia. US patent application 2022/056856 describes a propulsion system comprising a piston engine capable of operating on ammonia (NH₃) as the main fuel, and a pilot ignition system configured to ignite a pilot fuel to ignite a mixture of air and ammonia, the pilot fuel comprising hydrogen, biofuels and/or fossil fuels.

Patent applications US 2011/0259290 and US 2022/056856 do not specify the weight ratios between ammonia and the additional fuel used.

On another level, in the field of diesel or biodiesel hydrocarbon fuels with a low natural cetane number (typically close to 42 to 55), 2-ethylhexyl nitrate (EHN) has long been used as a cetane improver additive in diesel fuel. A higher cetane number ensures lower fuel consumption, reduced particulate matter and NOx emissions, faster cold engine start-up, reduced engine knocking and noise, and reduced engine wear. The reaction mechanism of EHN in the presence of a hydrocarbon diesel fuel has been studied, for example, in the scientific publication “The Autoignition Behaviour of Surrogate Diesel Fuel Mixtures and the Chemical Effects of 2-Ethylhexyl Nitrate (2-EHN) Cetane Improver” (vol. 108, section 4: Journal of fuels and lubricants (1999), pp. 1029-1045). This additive is produced industrially and widely used in commercial diesel fuels. More than fifty thousand tonnes of EHN have been produced annually in Europe since the 1980s. Other alkyl nitrates can also be used as additives to improve the cetane number of diesel fuel. The cetane number improvement effect is obtained when alkyl nitrate is added to diesel fuel at a concentration of around 0.03% by weight.

Fuel cetane improvers, such as alkyl nitrates, are not useful when fuels already have a naturally high cetane number, typically above 60. It should also be noted that above a value of 67, cetane numbers remain difficult to measure using standard measurement methods in accordance with EN 16715.

### SUMMARY OF THE INVENTION

The present disclosure provides a solution for improving the ignition and combustion of ammonia in standard engines by using, in very small proportions relative to the fuel, a pilot fuel consisting of a highly reactive hydrocarbon (with a high cetane number, greater than 60) containing an alkyl nitrate additive, such as 2-ethylhexyl nitrate (2-EHN or NEH). The Pilot Fuel Energy Fraction (PEF) added to the main ammonia fuel represents 0.1% to 5% of the total fuel (ammonia+pilot fuel).

The PEF of a pilot fuel is calculated using the following formula:

$$PEF = \frac{{m}_{carb .} * {PCI}_{carb .}}{{m}_{carb .} * {PCI}_{carb .} + {m}_{{NH}_{3}} * {PCI}_{{NH}_{3}}}$$

PCI: Lower calorific value
m_{carb}: mass of pilot fuel.
m_{NH3}: mass of the main fuel (ammonia).

The lower calorific value of the pilot fuel depends on the nature of the pilot fuel and therefore the weight percentage of the pilot fuel relative to the ammonia corresponding to the PEF varies according to the nature of the fuel for equivalent PEFs. For example, for a PEF of 1%, if the pilot fuel is HVO (acronym for “Hydrotreated Vegetable Oil”), the weight percentage of HVO relative to ammonia will be approximately 0.52%. It is unexpected that a very small energy fraction of pilot fuel can be used very effectively to improve, or even enable, the ignition and combustion of a fuel consisting mainly of ammonia, both hot and cold. The low proportion of pilot fuel added is advantageous in limiting the emission of greenhouse gas combustion products. The high cetane hydrocarbon and alkyl nitrate additive, which make up the pilot fuel, therefore act synergistically to improve the combustion of ammonia.

### BRIEF DESCRIPTION OF THE FIGURES

FIG. 1 shows the pressure measured in a combustion chamber relative to the crankshaft angle (CA) with injection for a CA=−10° of a pilot fuel consisting of dodecane containing 0%, 1% and 10% by weight of EHN.

FIG. 2 shows the temperature measured in a combustion chamber relative to the crankshaft angle (CA) with injection for CA=−10° of a pilot fuel consisting of dodecane containing 0%, 1% and 10% by weight of EHN.

FIG. 3 shows the heat release measured in a combustion chamber relative to the crankshaft angle (CA) with injection for a CA=−10° of a pilot fuel consisting of dodecane containing 0%, 1% and 10% by weight of EHN.

FIG. 4 shows the pressure measured in a combustion chamber relative to the crankshaft angle (CA) for cold (30° C.) and hot (80° C.) starts with injection at CA=−10° of a pilot fuel consisting of dodecane containing 10% by weight of EHN.

FIG. 5 shows the temperature measured in a combustion chamber relative to the crankshaft angle (CA) for cold (30° C.) and hot (80° C.) starts with injection for a CA=−10° of a pilot fuel consisting of dodecane containing 10% by weight EHN.

FIG. 6 shows the pressure measured in a combustion chamber relative to the crankshaft angle (CA) with injection for a CA=−10° of a pilot fuel consisting of HVO containing 0%, 1% and 10% by weight of EHN.

FIG. 7 shows the temperature measured in a combustion chamber relative to the crankshaft angle (CA) with injection for a CA=−10° of a pilot fuel consisting of HVO containing 0%, 1% and 10% by weight of EHN.

FIG. 8 shows the heat release measured in a combustion chamber relative to the crankshaft angle (CA) with injection for a CA=−10° of a pilot fuel consisting of HVO containing 0%, 1% and 10% by weight of EHN.

FIG. 9 shows the pressure measured in a combustion chamber relative to the crankshaft angle (CA) for cold (30° C.) and hot (80° C.) starts with injection for a CA=−10° of a pilot fuel consisting of HVO containing 30% by weight of EHN.

### DESCRIPTION OF THE INVENTION

This disclosure relates to a fuel for a combustion engine, in particular a compression ignition engine, using ammonia as the main fuel with the addition of a pilot fuel, said pilot fuel consisting of a hydrocarbon having a cetane number greater than 60 and containing about 0.02% to about 30.0% by weight of an additive consisting of an alkyl nitrate or a mixture of alkyl nitrates. In some embodiments, the hydrocarbon having a cetane number greater than 60 contains about 0.5% to about 30.0% by weight, or about 1.0% to about 30.0% by weight, or else about 1.0% to about 20.0% by weight, or else about 1.0% to about 10.0% by weight, of the additive consisting of an alkyl nitrate or a mixture of alkyl nitrates.

As indicated above, the combustion engine fuel according to the invention comprises ammonia as the main fuel, in an amount of about 95.00% to about 99.75% by weight.

As explained below, the pilot fuel is injected into the combustion chamber of an ignition engine before or after the ammonia is supplied. In some embodiments, the fuel thus formed (ammonia+pilot fuel) comprises about 0.25% to about 5.0% by weight of pilot fuel, relative to the total weight of the fuel (ammonia+pilot fuel). In some embodiments, when the sum of the amount of ammonia and the amount of pilot fuel is not equal to 100% by weight, the remainder to 100% is added to the fuel by one or more other additives, such as additives with lubricating, anti-corrosion or detergent functions. This additive or these additives may be contained in the pilot fuel or may be introduced separately into the combustion chamber.

The hydrocarbon in the pilot fuel is obtained from the distillation of petroleum or by synthesis from renewable raw materials. The pilot fuel may also be a pure substance in the family of linear or branched alkanes.

In some embodiments, the hydrocarbon in the pilot fuel having a high cetane number (>60) is selected from at least one of the following compounds:
a diesel fuel with low aromatic (<10%) and low polyaromatic (<10%) content,
a hydrotreated vegetable oil HVO (or renewable diesel from waste oils or renewable diesel from animal fats), for example of the type of HVO 100 fuel marketed by TotalEnergies,
an isoalkane, for example a mixture of isoparaffins of the Isane Biolife type marketed by TotalEnergies,
an n-alkane, such as dodecane,
a sustainable aviation fuel (SAF—according to the standards established by the “Carbon Offsetting and Reduction Scheme for International Aviation”, which is part of the ICAO/UN).

In some embodiments, the hydrocarbon in the pilot fuel is selected from a hydrotreated vegetable oil; an n-alkane, in particular dodecane; and mixtures thereof.

The additive, contained in an amount of about 0.02% to about 30.0% in the pilot fuel, represents about 0.0002% to about 1.5% of the total weight of the fuel.

The additive added to the pilot fuel consists of an alkyl nitrate or a mixture of alkyl nitrates selected from linear, branched or cyclic alkyl nitrates. In some embodiments, the alkyl nitrate is selected from linear alkyl nitrates comprising 4 to 36, advantageously 4 to 24 carbon atoms, branched alkyl nitrates comprising 4 to 36, advantageously 4 to 24 carbon atoms, cyclic alkyl nitrates (or cycloalkyl nitrates) containing 5 to 18 carbon atoms, and mixtures thereof. In some embodiments, the alkyl nitrate is selected from 2-ethylhexyl nitrate, cyclohexyl nitrate, dodecyl nitrate, n-nonyl nitrate, 2-tetradecyl-1-octadecyl nitrate, iso-nonyl nitrate, hexyl nitrate, 2-octyl nitrate, isononyl nitrate, 2-propylheptyl nitrate, a mixture of C₉-C₁₃ alkyl nitrates, and mixtures thereof. In some embodiments, the alkyl nitrate is 2-ethylhexyl nitrate alone or in admixture with one or more other alkyl nitrates as defined above, advantageously the alkyl nitrate is 2-ethylhexyl nitrate alone.

Mixtures of C₉-C₁₃ branched alkyl nitrates can be obtained from the corresponding mixtures of C₉-C₁₃ branched alcohols, for example the alcohols available from Exxon under the trade name Exxal™. As an example, a mixture of at least two branched alcohols selected from a C₉ branched alcohol, a C₁₀ branched alcohol, a C₁₁ branched alcohol, a C₁₂ branched alcohol and a C₁₃ branched alcohol, and then synthesise the corresponding mixture of alkyl nitrates.

The fuel consisting of ammonia, pilot fuel and optionally additive(s) can be used in an engine (in particular a combustion engine), for example a vehicle engine (such as a car, truck, tractor, etc.) or a ship engine (such as an oil tanker, container ship, etc.). One aspect of the present disclosure therefore relates to a vehicle or ship engine comprising a fuel as defined herein. The present disclosure also relates to a vehicle or ship comprising an engine as defined herein. Ammonia is generally injected into the combustion chamber of the engine in liquid form or admitted into the combustion chamber in gaseous form, premixed or not with air at the intake. The pilot fuel and ammonia (in liquefied form) are stored separately. The pilot fuel is injected into the combustion chamber before the ammonia is added, or after the ammonia is added (more specifically, injected after the ammonia is added in a gaseous form premixed with air, as in examples 1 and 2 below) or co-injected with ammonia via a dual injection system.

According to one aspect, the present disclosure thus relates to a process for obtaining fuel as defined herein, which comprises mixing, in the combustion chamber of the engine, the pilot fuel (as defined herein) and liquefied or gaseous ammonia, premixed or not with the intake air. In some embodiments, the pilot fuel is co-injected with the ammonia via a dual injection system into the combustion chamber. In certain embodiments, the pilot fuel is injected into the combustion chamber ahead of the intake or injection of ammonia. In some embodiments, the pilot fuel is injected into the combustion chamber after the intake or injection of ammonia. The injection of pilot fuel aids the ignition of ammonia, which can be difficult or even impossible under certain engine conditions (such as richness, temperature or load).

The use of the pilot fuel, as defined herein, provides improved ignition and combustion performance compared to ammonia alone, and helps ensure cold ignition.

In one aspect, the present disclosure therefore relates to the use of the pilot fuel as defined herein, in an amount of 0.25% to 5.0% by weight in a fuel comprising about 95.00% to about 99.75% by weight of ammonia, as an ignition improver for said fuel. The present disclosure also relates to a method for improving the ignition, in an engine, of a fuel comprising from about 95.00% to about 99.75% by weight of ammonia, which method comprises adding to the ammonia a pilot fuel as defined herein in an amount of from 0.25% to 5.0% by weight.

According to one aspect, the present disclosure relates to a vehicle or ship engine containing (operating with) a fuel as defined above.

According to one aspect, the present disclosure relates to a vehicle or a ship comprising an engine as defined above.

The present disclosure is illustrated by the following examples, which are provided for illustrative purposes only.

### EXAMPLES

Fuel performance tests in accordance with the present disclosure have been carried out with a controlled reactivity compression ignition engine (of the “RCCI” type). The operation of an engine in RCCI mode consists of igniting a low-reactivity fuel by the energy input of a high-reactivity fuel. The low-reactivity fuel, injected or admitted indirectly, enters the engine during the intake phase. The high-reactivity fuel, present in small quantities in the overall mixture, is injected directly into the cylinder in one or more injections, as in a compression ignition engine. This involves premixing a low-reactivity fuel with air at the intake, where the richness is then known, and igniting it with one or more direct injections of a high-reactivity fuel in small quantities. As a result, each point can be controlled independently: pre-mix richness, conditions of the low-reactivity mixture (temperature, pressure) and injection(s) of the high-reactivity fuel (pressure, duration, phasing).

Studies with an RCCI engine allow the reactivity of fuel charges to be defined appropriately, and their relative quantities, timing and combustion can be adjusted to achieve optimum operation.

The experimental data collected for the various examples are given for an imposed indicated mean pressure (IMP) and an imposed air/NH₃ mixture ratio.

The indicated mean pressure (IMP) corresponds to the mean pressure in the cylinder due to fuel combustion. It represents the work done by this combustion relative to the engine displacement.

The experimental data measured in the combustion chamber are:
P: the pressure in the combustion chamber.
T: temperature in the combustion chamber.
Q: the heat produced by combustion

These experimental data are reported as a function of the crankshaft angle (CA=0°⇔Top Dead Centre (TDC))

For examples 1 and 2, the pilot fuel is injected at a CA angle of −10° after the introduction of ammonia admitted in gaseous phase premixed with air.

### Example 1

In this example, the pilot fuel is dodecane (cetane number >67) alone (0% 2-ethylhexyl nitrate) or containing 1% or 10% by mass of 2-ethylhexyl nitrate (EHN). The main fuel is ammonia.

The quantity of pilot fuel injected corresponds to a PEF of 2% in energy input relative to the total energy input of the ammonia+pilot fuel mixture. The weight fraction of pilot fuel in the total fuel (ammonia+pilot fuel) is 0.9%.

Steady State Operation when Hot (Intake Temperature=80° C.)

The engine operating point corresponds to an IMP of 3 bar for an Air/NH₃ ratio of Φ=0.7 with an intake temperature of 80° C. The experimental data is collected after at least 200 engine operating cycles.

Under these operating conditions, ammonia used alone without pilot fuel does not ignite.

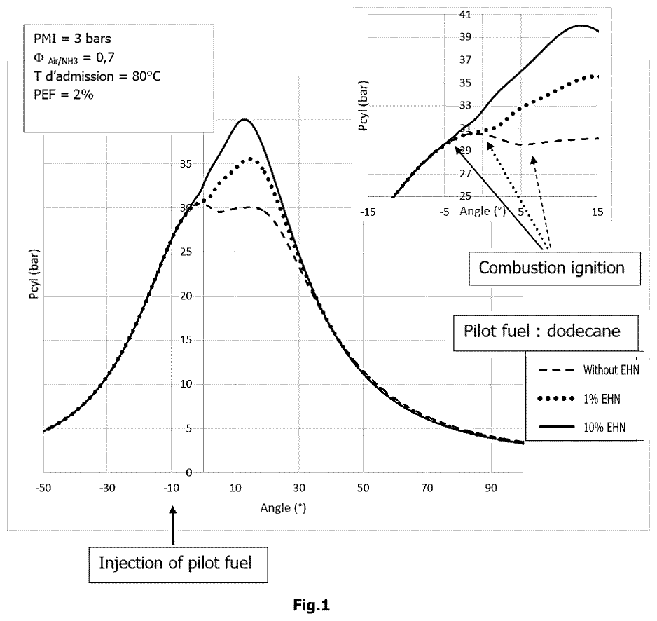

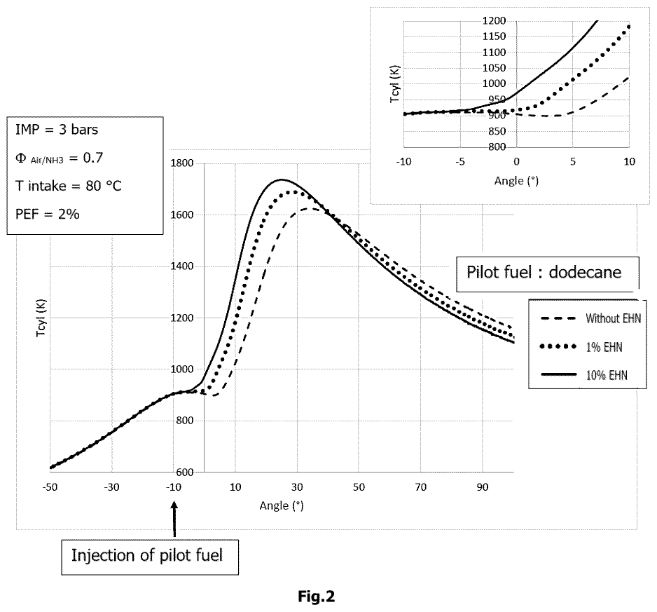

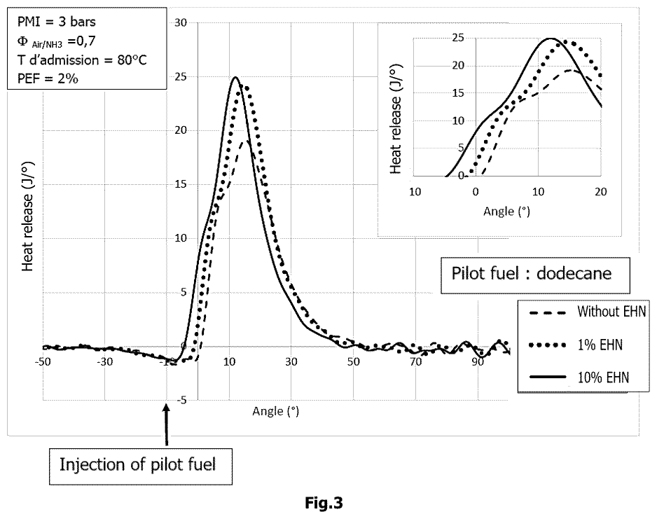

Referring to FIGS. 1, 2 and 3, we observe that:
When the pilot fuel consists of dodecane without EHN, a first pressure peak occurs almost at TDC (mixture compression, CA=) 0° and a second around 20°, with peaks in heat release due to the start of combustion and temperature increase observed at approximately an angle CA=5°.
When the pilot fuel consists of dodecane containing 1% by weight of EHN, the pressure increases continuously after approximately an angle CA=0°. A very slight plateau is observed, but the pressure continues to increase up to approximately an angle CA=20°. The combustion is initiated at approximately an angle CA=0° with heat production and a temperature increase.
When the pilot fuel consists of dodecane containing 10% by weight of EHN, a continuous increase in pressure is observed following the pressure peak caused by compression, reaching a level higher than that observed for pilot fuel containing 1% EHN. The combustion therefore starts at an CA angle of approximately −2.5°. This advance in the initiation of heat production is also visible on the temperature and heat release curve as a function of CA.

In conclusion, the injection of highly reactive alkane pilot fuel (with a high cetane number), dodecane in this example, containing up to 10% EHN leads to a significant gain in ignition delay, combustion and heat produced.

The same type of test conducted with a dodecane pilot fuel containing 30% by weight of EHN showed no significant difference compared to the test conducted with a dodecane pilot fuel containing 10% by weight of EHN.

### Cold and Hot Start

The advantage of the pilot fuel as described herein has also been demonstrated with regard to cold ignition of the fuel. The engine operating point corresponds to an IMP of approximately 8.5 bar for a richness air/NH₃ of Φ=1 with an intake temperature of 80° C. when hot and 30° C. when cold. The PEF of the fuel is 2%.

Under these operating conditions, when cold, at an intake temperature of 30° C., there is no combustion initiation for:
ammonia alone,
ammonia+pilot fuel consisting of dodecane alone (not containing EHN),
ammonia+pilot fuel consisting of dodecane containing 1% by weight of EHN.

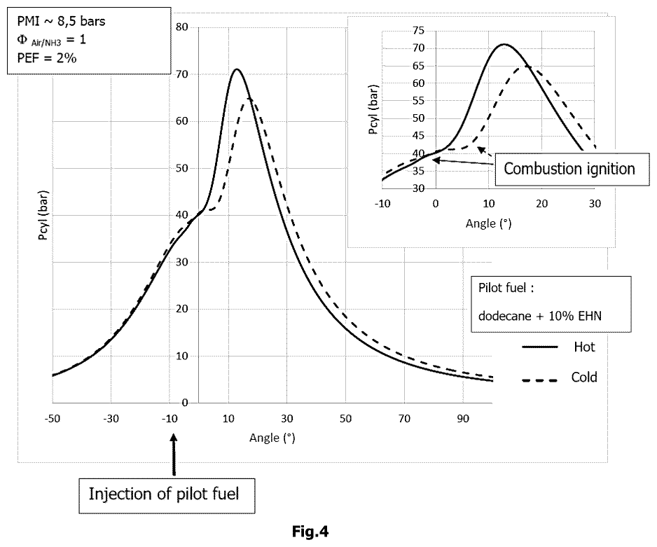

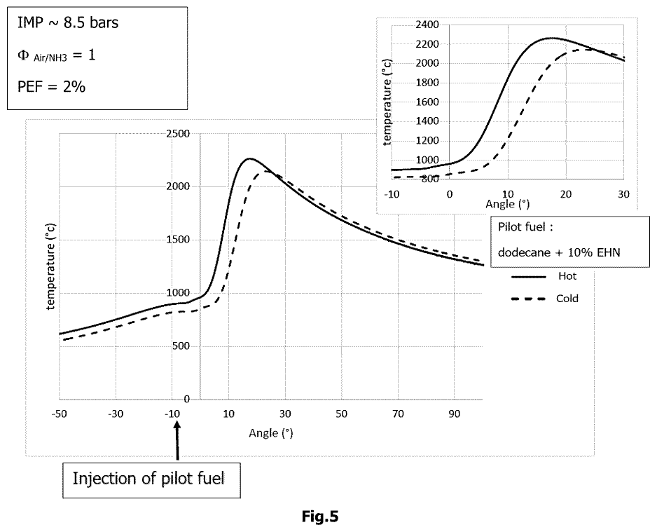

With reference to FIGS. 4 and 5, combustion initiation is observed in both hot and cold conditions with dodecane pilot fuel containing 10% by weight of EHN.

Comparing cold and hot operation in FIGS. 4 and 5, we observe that:
The IMP is higher when cold, since combustion lasts longer, more energy is recovered throughout the cycle, even if the peak of heat release is lower.
Combustion starts later at cold temperatures for approximately an CA angle of 5° than at hot temperatures, where it starts for approximately an CA angle of 0°.
The combustion pressure and temperature are lower when cold.

The same type of test conducted with a dodecane pilot fuel containing 30% by weight of EHN shows no significant difference from that conducted with a dodecane pilot fuel containing 10% by weight of EHN.

In conclusion for example 1, the pilot fuel consisting of dodecane, containing 10% by weight of EHN, present in the entire fuel at a low PEF of 2% (corresponding to a weight fraction of 110 ppm to 1200 ppm of the total fuel (ammonia+pilot fuel)) allows significantly improving engine performance at both hot and cold temperatures.

An increase in the EHN content in this example to above 10% by weight does not result in any significant performance gains.

Tables 1 and 2 summarise the results of example 1.

TABLE 1

| | Operating conditions | | |
|---|---|---|---|
| | IMP = 3 bar | | |
| | Φ_{Air/NH3)} = 0.7 | | |
| | T intake = 80° C. | | |
| | PEF = 2% | | |
| | Pilot fuel injection CA = −10° | | |
| | | IMP coefficient of | |
| | CA angle of | variation (Covariance | |
| | combustion | of the IMP in | Pmax |
| Fuel (% by weight) | initiation | % over 200 cycles)* | (bars) |
| NH₃ alone (100%) | No | — | No |
| | combustion | | combustion |
| NH₃ 99.1% + 0.9% | ~5° | 9% | 30 (2 peaks) |
| dodecane | | | |
| NH₃ 99.1% + 0.9% | ~0° | 6% | 35 |
| (dodecane + 1% by | | | |
| weight of EHN) | | | |
| NH₃ 99.1% + 0.9% | ~−2.5° | 5% | 40 |
| (dodecane + 10% by | | | |
| weight of EHN) | | | |

*Combustion stability indicator over 200 cycles.

TABLE 2

Operating conditions
IMP~8.5 bar
Φ(_{Air/NH3)} = 1
PEF = 2%
Pilot fuel injection at CA = −10°

| | Angle CA of | Angle CA of |
|---|---|---|
| | combustion initia- | combustion initia- |
| | tion when hot | tion when cold |
| Fuel (% by weight) | (80° C.) | (30° C.) |
| NH₃ alone | — | No combustion |
| NH₃ 99.1% + 0.9% | | No combustion |
| dodecane | | |
| NH₃ 99.1% + 0.9% | | No combustion |
| (dodecane + 1% by | | |
| weight of EHN) | | |
| NH₃ 99.1% + 0.9% | ~0° | ~5° |
| (dodecane + 10% by | | |
| weight of EHN) | | |

### Example 2

In this example, the pilot fuel is hydrotreated vegetable oil HVO 100 (with a cetane number >60) marketed by TotalEnergies, either alone (0% 2-ethylhexyl nitrate) or containing 1% or 10% by weight of 2-ethylhexyl nitrate (EHN). The main fuel is ammonia.

The quantity of pilot fuel injected corresponds to a PEF of 2% in terms of energy input, relative to the total energy input of the mixture (ammonia+pilot fuel). The weight fraction of the pilot fuel in the total fuel (ammonia+pilot fuel) is 1.1%.

### Steady-State Operation (Intake Temperature=80° C.)

The engine operating point corresponds to an IMP of 3 bar for a richness Air/NH₃ of Φ=0.7 with an intake temperature of 80° C. The experimental data is collected after at least 200 engine operating cycles.

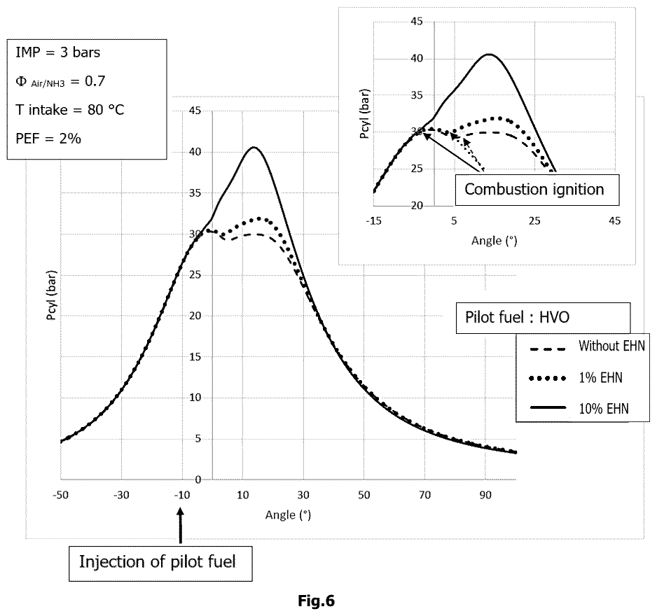

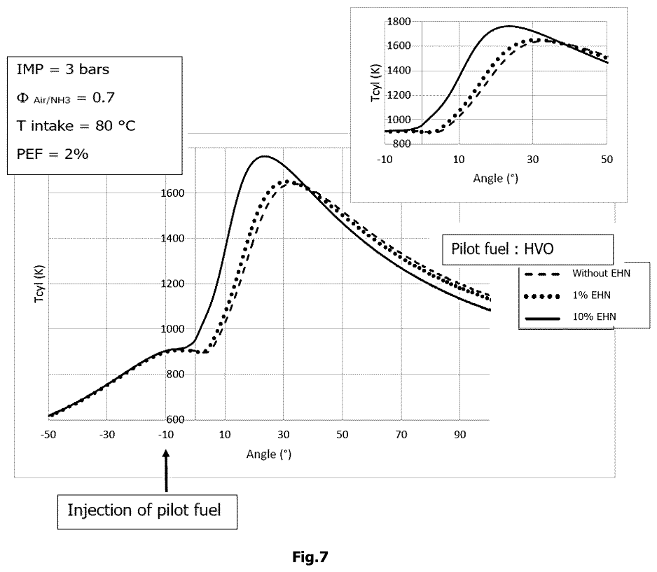

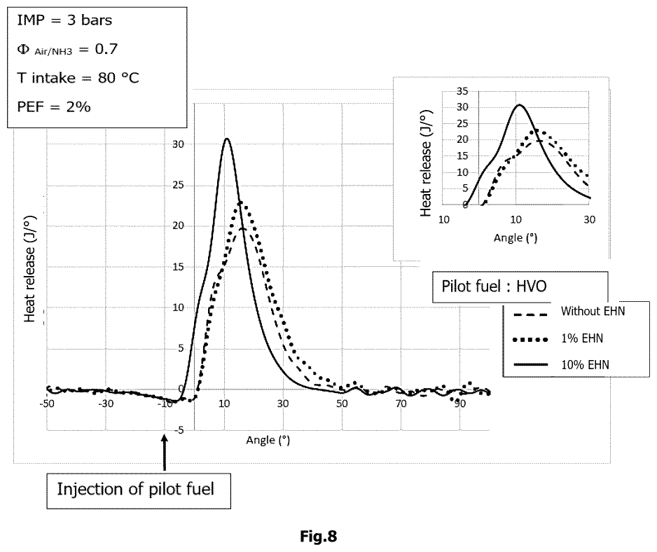

Referring to FIGS. 6, 7 and 8, we observe that:
When the pilot fuel consists of HVO without EHN, a first pressure peak occurs almost at TDC at approximately an angle CA=0° and a second peak at approximately an angle CA=20°, the peak of heat release due to the start of combustion and temperature increase occurring at approximately an angle CA=5°.
When the pilot fuel consists of HVO containing 1% by weight of EHN, the fuel combustion curves are similar to those obtained for the pilot fuel consisting of HVO without EHN. The pilot fuel consisting of HVO containing 1% by weight of EHN provides a small but significant gain in terms of ignition advance, peak of heat pressure and temperature.
When the pilot fuel consists of HVO containing 10% by weight of EHN, a continuous increase in pressure is observed following the pressure peak caused by compression, reaching a higher level than that observed for the pilot fuel containing 1% of EHN. The combustion initiation begins at approximately an angle CA of −2.5°. This advance in the initiation of heat production is also visible on the temperature and heat release curve as a function of CA.

In conclusion, the injection of the pilot fuel consisting of HVO (with a cetane number >67) containing 10% of EHN leads to a significant reduction in the combustion initiation delay and heat produced.

The same type of test conducted with a pilot fuel consisting of HVO containing 30% by weight of EHN showed no significant difference compared to the test conducted with a pilot fuel consisting of HVO containing 10% by weight of EHN.

### Cold and Hot Start

The advantages of the pilot fuel described herein have also been demonstrated with regard to cold fuel ignition. The engine operating point corresponds to an IMP of approximately 8.5 bar for a richness Air/NH₃ of Φ=1 with an intake temperature of 80° C. when hot and 30° C. when cold. The fuel PEF is 2%.

Under the operating conditions, when cold, at an intake temperature of 30° C., there is no combustion initiation for:
ammonia alone,
ammonia+pilot fuel consisting of HVO alone (not containing EHN),
ammonia+pilot fuel consisting of HVO containing 1% by weight of EHN,
ammonia+pilot fuel consisting of HVO containing 10% by weight of EHN.

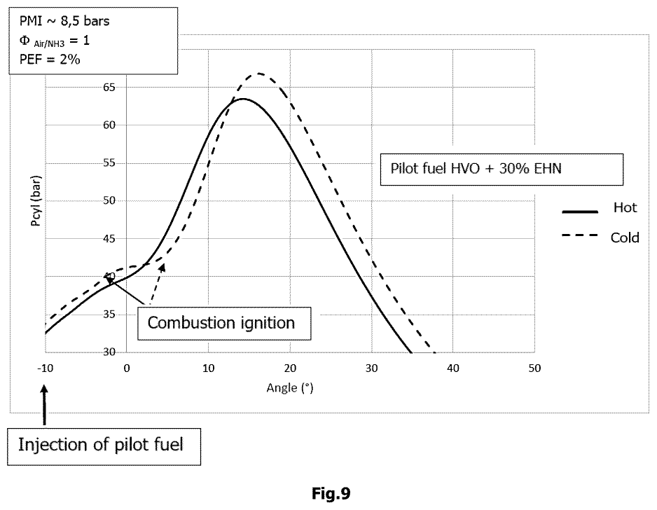

With reference to FIGS. 9 and 10, combustion initiation is observed in both hot and cold conditions with the pilot fuel consisting of HVO containing 30% by weight of EHN.

Comparing cold and hot operation in FIGS. 9 and 10, we observe that:
Combustion starts later in cold conditions at approximately an angle CA of =5° compared to a hot start at approximately an angle CA of =0° and lasts for a shorter period of time for an injection carried out at the same time.

In conclusion for example 2, the pilot fuel consisting of HVO containing at least 10% EHN present in the total fuel at a low PEF of 2% (corresponding to a weight fraction of 0.14% of the total fuel (ammonia+pilot fuel)) significantly improves engine performance.

Tables 3 and 4 summarise the results of example 2.

TABLE 3

| | Operating conditions | | |
|---|---|---|---|
| | IMP = 3 bar | | |
| | Φ_{Air/NH3} = 0.7 | | |
| | Temperature intake = 80° C. | | |
| | PEF = 2% | | |
| | Pilot fuel injection at CA = −10° | | |
| | Angle | Combustion | |
| | CA of | environment | |
| | combustion | (CA₅₀, 200 | Pmax |
| Fuel (% by weight) | initiation | cycles)* | (bars) |
| NH₃ alone (100%) | No | No | No |
| | combustion | combustion | combustion |
| NH₃ 98.9% + 1.1% HVO | ~5 | 20 | 30 (2 peaks) |
| NH₃ 98.9% + 1.1% | ~5 | 18 | 32 |
| (HVO + 1% by weight of | | | |
| EHN) | | | |
| NH₃ 98.9% + 1.1% | ~−2.5° | 13 | 40 |
| (HVO + 10% by weight of | | | |
| EHN) | | | |

*CA₅₀°: Average angle determined to achieve 50% of combustion energy.

TABLE 4

| | Operating conditions | |
|---|---|---|
| | PMI~8.5 bar | |
| | Φ_{Air/NH3} = 1 | |
| | PEF = 2% | |
| | Pilot fuel injection at CA = −10° | |
| | Angle CA of | Angle CA of |
| | combustion initia- | combustion initia- |
| | tion when hot | tion when cold |
| Fuel (% by weight) | (80° C.) | (30° C.) |
| NH₃ alone | — | No combustion |
| NH₃ 98.9% + 1.1% HVO | | No combustion |
| NH₃ 98.9% + 1.1% | | No combustion |
| (HVO + 1% by weight of EHN) | | |
| NH₃ 98.9% + 1.1% | | No combustion |
| (HVO + 10% by mass of EHN) | | |
| NH₃ 98.9% + 1.1% | ~0° | ~5 |
| (HVO + 30% by weight of EHN) | | |

1. A combustion engine fuel comprising about 95.00% to about 99.75% by weight of ammonia and about 0.25% to about 5.00% by weight of a pilot fuel consisting of a hydrocarbon having a cetane number greater than 60 and containing about 0.02% to about 30.0% by weight of an alkyl nitrate or a mixture of alkyl nitrates.

2. The fuel according to claim 1, wherein the pilot fuel contains from about 0.5% to about 30.0% by weight of the alkyl nitrate or mixture of alkyl nitrates.

3. The fuel according to claim 1, wherein the hydrocarbon is selected from the group consisting of: a diesel fuel with low aromatic content (<10%) and low polyaromatic content (<10%), a hydrotreated vegetable oil (HVO), an iso-alkane, an n-alkane, a sustainable aviation fuel and mixtures thereof.

4. The fuel according to claim 1, wherein the alkyl nitrate is a linear alkyl nitrate having 4 to 36 carbon atoms, a branched alkyl nitrate having 4 to 36 carbon atoms, or a cyclic alkyl nitrate having 5 to 18 carbon atoms.

5. The fuel according to claim 1, wherein the alkyl nitrate is selected from the group consisting of 2-ethylhexyl nitrate, cyclohexyl nitrate, dodecyl nitrate, n-nonyl nitrate, 2-tetradecyl-1-octadecyl nitrate, hexyl nitrate, 2-octyl nitrate, isononyl nitrate, 2-propylheptyl nitrate, and a mixture of C₉-C₁₃ branched alkyl nitrates.

6. The fuel according to claim 1, wherein the alkyl nitrate is 2-ethylhexyl nitrate.

7. A process for obtaining the fuel according to claim 1, which comprises mixing, in the combustion chamber of an engine, the pilot fuel and liquefied or gaseous ammonia, premixed or not with the intake air.

8. The process according to claim 7, wherein the pilot fuel is co-injected with the ammonia via a dual injection system into the combustion chamber.

9. The process according to claim 7, wherein the pilot fuel is injected into the combustion chamber in advance of the intake or injection of ammonia.

10. The process according to claim 7, wherein the pilot fuel is injected into the combustion chamber after the intake or injection of ammonia.

11. A vehicle or ship engine containing the fuel as defined in claim 1.

12. A vehicle or ship comprising the engine as defined in claim 11.

13. (canceled)

14. A method for improving the ignition of an ammonia-based fuel, the method comprising adding to said fuel a pilot fuel consisting of about 70.0% to about 99.98% by weight of a hydrocarbon having a cetane number greater than 60 and about 0.02% to about 30.0% by weight of an alkyl nitrate or a mixture of alkyl nitrates, such that the fuel comprises about 95% to about 99.75% by weight of ammonia and about 0.25% to about 5.0% by weight of said pilot fuel.

15. The fuel according to claim 2, wherein the pilot fuel contains from about 1.0% to about 30.0% by weight of the alkyl nitrate or mixture of alkyl nitrates.

16. The fuel according to claim 2, wherein the pilot fuel contains from about 1.0% to about 20.0% by weight of the alkyl nitrate or mixture of alkyl nitrates.

17. The fuel according to claim 2, wherein the pilot fuel contains from about 1.0% to about 10.0% by weight of the alkyl nitrate or mixture of alkyl nitrates.
